(19) United States
(12) Patent Application Publication
(10) Pub. No.: US 2025/0285082 A1
(43) Pub. Date: Sep. 11, 2025

(54) SKILL LEVEL INFERENCE USING MACHINE LEARNING

(71) Applicant: SkyHive Technologies Holdings Inc., Palo Alto, CA (US)

(72) Inventors: MOHAN REDDY, Fremont, CA (US); YURI YERASTOV, Hayward, CA (US); SEAN HINTON, Mountain View, CA (US)

(21) Appl. No.: 18/596,511

(22) Filed: Mar. 5, 2024

(51) Int. Cl. G06Q 10/1053; G06F 40/284; G06F 40/295; G06Q 10/0631

(52) U.S. Cl. CPC G06Q 10/1053; G06F 40/284; G06F 40/295; G06Q 10/063112

(57) ABSTRACT

A system for document analysis and generation based on graph structures is disclosed. The system is programmed to maintain graph structures for skill names and skill-related categories. The system is further programmed to train one or more machine learning (ML) models based on skill-related documents as training data and the graph structures. The ML models recognize entities in the training data that fall into the skill-related categories as named entities, identify pairs of named entities likely to correspond to skill names and corresponding skill levels, and inferring an overall skill level for each group of related skill names. In addition, the system is programmed to transform an input document into a skill assessment using the trained one or more ML models and access or update specific documents that include specific skills and skill levels.

### TECHNICAL FIELD

The present disclosure relates to text analysis and prediction, and more particularly to transforming skill-related text to skill assessments using machine learning (ML) models based on graphs and classifications for skill names and skill levels.

### BACKGROUND

The complexity of the English language means that desired information could be expressed in different forms and at different degrees of clarity. In today's labor market, for example, many resumes are to be reviewed to determine how to allocate resources and increase productivity. However, it can be challenging to transform a resume to a proper skill assessment indicating the skills possessed by an individual and the corresponding skill levels.

### SUMMARY

The appended claims may serve as a summary of the invention.

### BRIEF DESCRIPTION OF THE DRAWINGS

Example embodiments will now be described by way of non-limiting examples with reference to the accompanying drawings, in which:

FIG. 1 illustrates an example networked computer system in which various embodiments may be practiced.

FIG. 2 illustrates an example resume.

FIG. 3 illustrates an example ontology of classes and categories for named entity recognition.

FIG. 4 illustrates an example result of named entity recognition.

FIG. 5 illustrates an example process performed by a computer application server in accordance with disclosed embodiments.

FIG. 6 illustrates a computer system upon which various embodiments may be implemented.

### DETAILED DESCRIPTION OF CERTAIN EMBODIMENTS

In the following description, for the purposes of explanation, numerous specific details are set forth in order to provide a thorough understanding of the example embodiment(s) of the present invention. It will be apparent, however, that the example embodiment(s) may be practiced without these specific details. In other instances, well-known structures and devices are shown in block diagram form in order to avoid unnecessarily obscuring the example embodiment(s).

### 1. General Overview

A system for document analysis and generation based on graph structures is disclosed. The system is programmed to maintain graph structures for skill names and skill-related categories. The system is further programmed to train one or more ML models based on skill-related documents as training data and the graph structures. The ML models recognize entities in the training data that fall into the skill-related categories as named entities (NEs), identify pairs of NEs likely to correspond to skill names and corresponding skill levels, and inferring an overall skill level for each group of related skill names. In addition, the system is programmed to transform an input document into a skill assessment using the trained one or more ML models and access or update specific documents that include specific skills and skill levels.

In some embodiments, given an input document, such as a resume, the system is programmed to identify text segments from the input document. For example, a text segment can correspond to a sentence in a Skills section or a subsection in a Work Experience section. Each text segment defines a minimal scope likely to describe a skill and a corresponding skill level.

In some embodiments, the system is programmed to then tag entities in the text segments with specific categories using a first ML model, which can include a transformer. The specific categories fall into a skill name class and a skill level class, all of which are maintained in an ontology. For example, the text “Embedded Systems Computer Engineer” in a text segment can be tagged with a job title category in the skill name class, the text “December 2016-July 2019” in the text segment can be tagged with a duration category in the skill level class.

In some embodiments, the system is programed to next identify each pair of NEs likely to correspond to a skill name and a corresponding skill level, and generate an encoding for the pair of NEs using a second ML model, which can also include a transformer. For example, the text “Embedded Systems Computer Engineer” and the text “December 2016-July 2019” are in the same text segment and can form a first pair of NEs for which an encoding is generated. As opposed to the first ML model's efficiently recognizing NEs, the second ML model can encode more of a span for each token to better capture the relationship between the tokens, which can include the two tokens of a pair of NE.

In some embodiments, the system is programmed to, for each set of pairs of NEs that correspond to the same skill name or a group of related skill names, determine an overall skill level using a third ML model, which can be a reinforcement learning model. For example, the text “C++ programming” and the text “expert” could form a second pair of NEs, and the set of these two pairs of NEs that both correspond to the skill name of embedded system could be used to determine an overall skill level for the skill name. The reinforcement learning model can be set up with initial training data, such as synthetic data, and continuously improved as new input data is received and the output of an estimated skill level is validated by a user.

In some embodiments, the system is programmed to generate a skill assessment that indicates a skill level for each skill identifiable in the input document. The system is programmed to access or update predetermined documents based on such skill assessments. For example, a predetermined document can be a job description. The system can be programmed to match the skill assessment to the job description to determine whether the job can be filled. The system can further be programmed to update the job description, after a number of skill assessments fail to appropriately match the job description, based on aggregate skill levels in these skill assessments.

The system disclosed herein has several technical benefits. By utilizing specifically selected and trained ML models and predetermined graph structures, the system can systematically and efficiently process a large number of input documents to extract desired information and make appropriate decisions. Resumes or similar documents that contain highly variable expressions in vastly different formats are quickly transformed into skill assessments that are easily analyzed by intelligently identifying portions of the documents from which appropriate skill level information can be inferred. Reinforcement learning enables continuous exploration of a large state space and improvement of prediction results.

### 2. Example Computing Environments

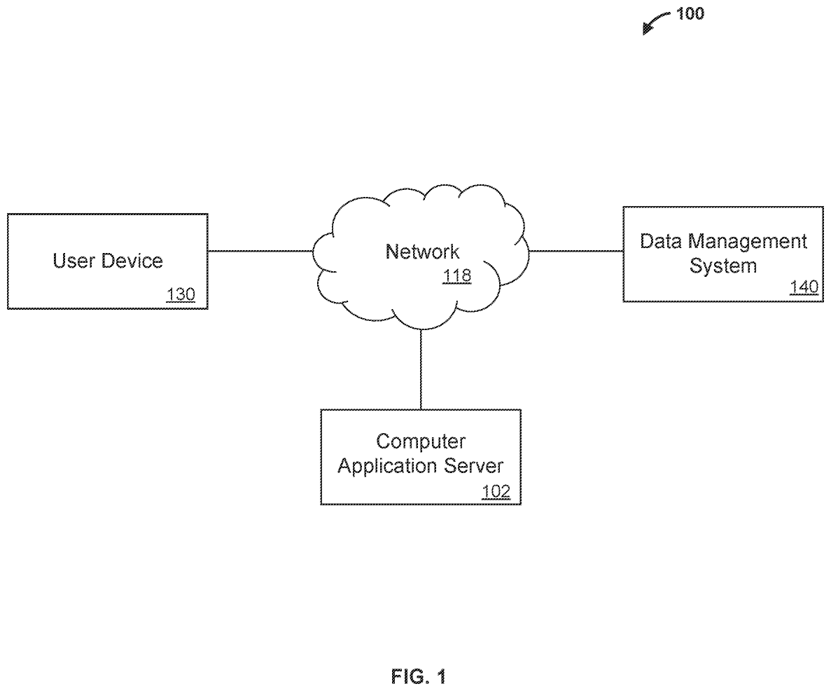

FIG. 1 illustrates an example networked computer system in which various embodiments may be practiced. FIG. 1 is shown in simplified, schematic format for purposes of illustrating a clear example and other embodiments may include more, fewer, or different elements.

In some embodiments, a networked computer system 100 comprises a computer application server (“server”) 102, a user device 130, and a data management system 140, which are communicatively coupled through direct physical connections or via a network 118.

In some embodiments, the server 102 is programmed or configured to manage determination of skills and corresponding skill levels based on predetermined data structures related to skill names and skill levels. The management includes maintaining data structures and datasets related to skill names and skill levels. The management also includes building and executing one or more ML models that transform a resume or another document that describes an individual's experience to a skill assessment or another document that describes what skills the individual possesses and the levels of these skills. The server 102 is programmed or configured to utilize the determined skill levels to update existing ML models, data structures, or datasets. The server 102 can comprise any centralized or distributed computing facility with sufficient computing power in data processing, data storage, and network communication for performing the above-mentioned functions.

In some embodiments, the user device 130 is programmed or configured to submit skill-related data for a user, such as a resume, and receive a response of processing the skill-related data, such as a result of comparing the generated skill assessment with another document that indicates skill requirements. The user device 130 can comprise a personal computing device, such as s desktop computer, laptop computer, tablet computer, smartphone, or wearable device.

In some embodiments, the data management system 140 is programmed or configured to host a database of skill-related data, which can be used to train the one or more ML models. The data management system 140 can thus be programmed to receive a request for skill-related data and respond to the request with skill-related data from the database. The data management system 140 can generally be similar to the server 102 and comprise any computing facility with sufficient computing power in data processing, data storage, and network communication for performing the above-mentioned functions.

The network 118 may be implemented by any medium or mechanism that provides for the exchange of data between the various elements of FIG. 1. Examples of the network 118 include, without limitation, one or more of a cellular network, communicatively coupled with a data connection to the computing devices over a cellular antenna, a near-field communication (NFC) network, a Local Area Network (LAN), a Wide Area Network (WAN), or the Internet, a terrestrial or satellite link.

In some embodiments, the server 102 is programmed to collect training data for training the one or more ML models. Such input data can come from the user device 130 or a similar device, or the data management system 140 or a similar system. The server 102 is programmed to build the one or more ML models using the input data. Subsequently, the server 102 is programmed to receive skill-related data for an individual as input data from the user device 130, execute the one or more ML models on the input data to generate a skill assessment and related data as output data, and transmit a response based on the output data to the input data.

### 3. Functional Descriptions

### 3.1. Identifying Named Entities

In some embodiments, the server 102 is programmed to maintain a skill graph of skill names. The skill graph includes groups of related skill names, where one of the related skill names in a group can be selected as the representative skill name for the group. One example knowledge graph is the knowledge graph described in U.S. Pat. No. 17,241,069 issued on Nov. 2, 2021. In the knowledge, each node represents a word, and each edge represents a syntactic relationship. A skill name is represented by a specific subgraph. A group of related skill names can be determined by an expanded subgraph within a certain distance away from the specific subgraph, for instance.

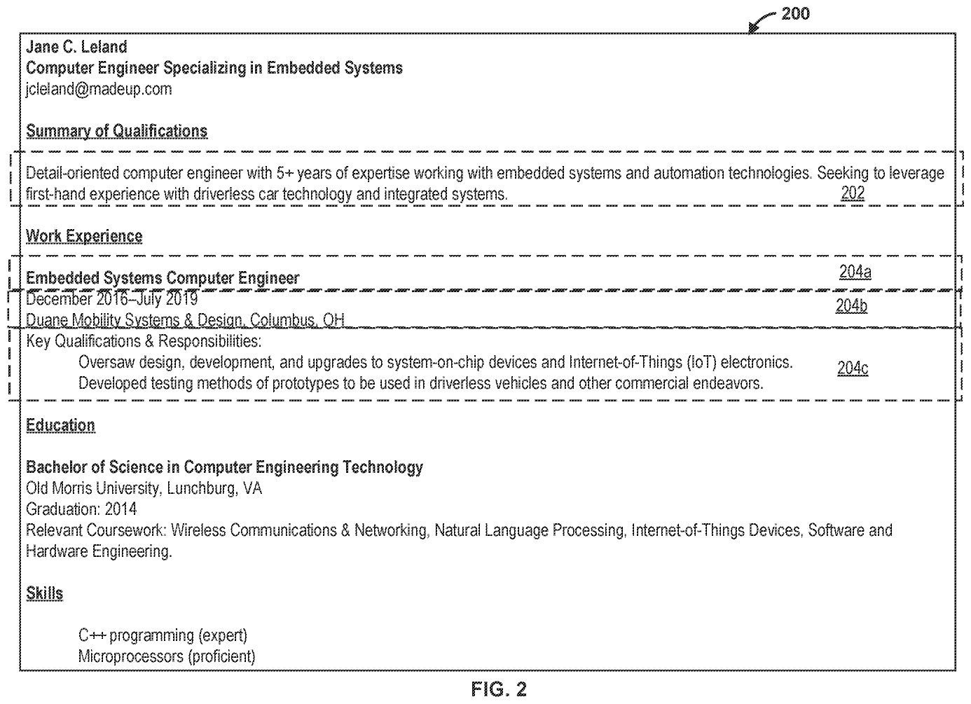

In some embodiments, the server 102 is programmed to receive a document including information related to a person's skills, such as a resume. A resume generally includes sections that each include subsections. FIG. 2 illustrates an example resume. The resume 200 includes several common sections, such as the “Summary of Qualifications” section and the “Work Experience” section. The “Summary of Qualifications” sections has one subsection 202. The “Work Experiences” section has also one subsection. Such a subsection can have several portions, including a first portion of an experience title, such as the portion 204a, a second portion of a header, such as the portion 204b, and a third portion of a description, such as the portion 204c. A header can include dates and geographical locations.

In some embodiments, the server 102 is programmed to first recognize the subsections in the document based on predetermined structures of subsections. The server 102 can be programmed to further break each subsection into a set of sentences based on punctuations (e.g., separated by periods, semicolons, or newlines). The server 102 can then be programmed to identify a set of text segments from the document. For certain sections of a resume, such as a section that indicates work or education histories, each text segment can correspond to a subsection. For other sections, each text segment can correspond to each sentence (or each line in the absence of a sentence structure).

In some embodiments, the server 102 is programmed to identify NEs that belong to specific categories from the set of text segments. The specific categories fall into two classes, the skill name class and the skill level class. For example, the skill name class can include the skill category, job title category, or credential category that corresponds to a skill name that represents a group of related skill names or skills, and the skill level class can include the time category, level category, or organization category that corresponds to a skill level.

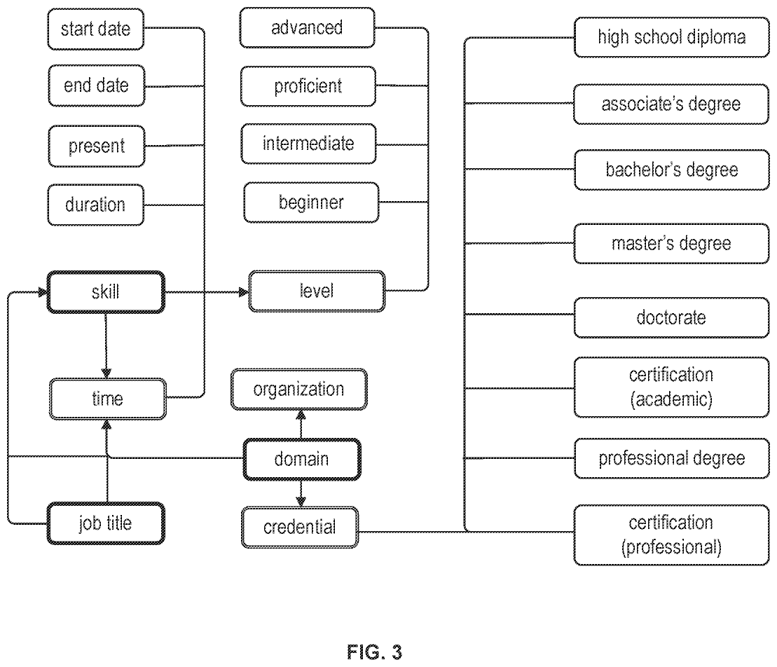

FIG. 3 illustrates an example ontology of classes and categories for named entity recognition. Each category that is in the skill name class is shown in a box of a bold rim at the head an arrow, while each category that is in the skill level class is shown in a box of a double rim at the tail of an arrow. The values shown in other boxes correspond to sub-categories or possible entities. For example, a time can be represented as a combination of a start date and an end date or directly as a duration.

In some embodiments, the server 102 is programmed to perform named entity recognition (NER) using a first transformer-based ML model, such as RoBERTa described in the paper by Liu at al., arXiv:1907.11692v1 [cs.CL] 26 Jul. 2019. The first ML model may have been trained on a standard dataset for NER that defines a fixed set of categories for NEs. An example of such a standard dataset is the CoNLL—2003 dataset described in the paper by Sang et al., arXiv:cs/0306050v1 [cs.CL] 12 Jun. 2003, which covers four categories, namely organization, person, location, and other. The server 102 can be programmed to specifically train the first ML model on a custom dataset for recognizing the specific categories. Other existing techniques for NER could also be used as long as they are specifically trained or designed to enable recognition of the predetermined categories.

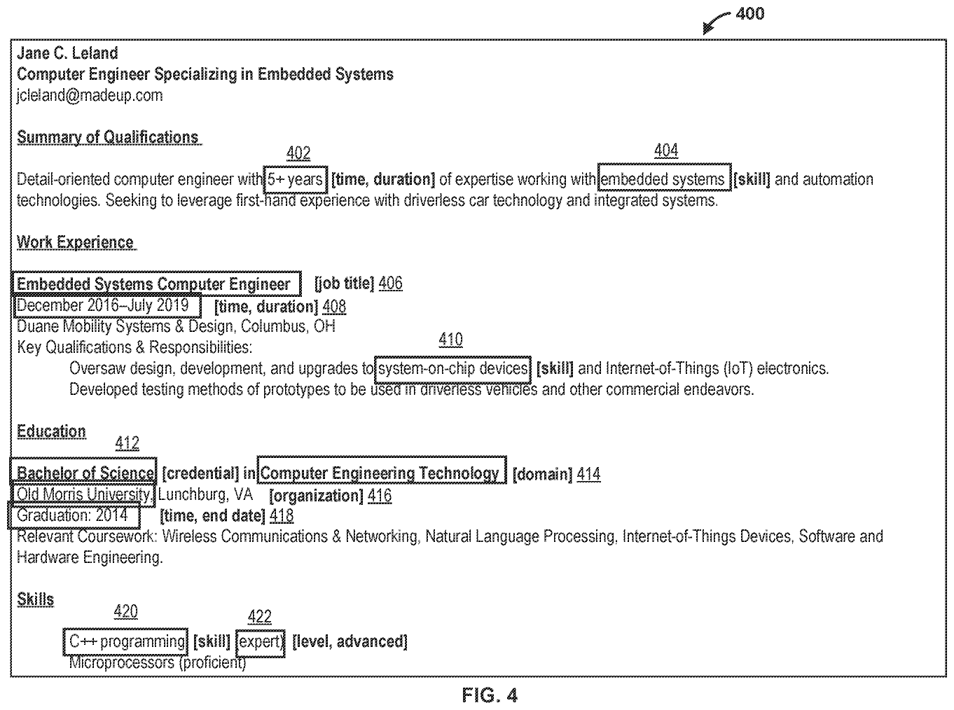

FIG. 4 illustrates an example result of named entity recognition. This example shows a partial result 400 of performing NER on the resume illustrated in FIG. 2 with tags for select NEs. The entity 402 (enclosed in the corresponding box) is tagged with the time/duration category. The entity 404 is tagged with the skill category. The entity 406 is tagged with the job title category. The entity 408 is tagged with the time/duration category. The entity 410 is tagged with the skill category. The entity 412 is tagged with the credential category. The entity 414 is tagged with the domain category. The entity 416 is tagged with the organization category. The entity 418 is tagged with the time/end date category. The entity 420 is tagged with the skill category. The entity 422 is tagged with the level/advanced category.

In some embodiments, the server 102 is programmed to recognize specific time-related entities. The server 102 can be configured to set up a mapping to derive a duration when only one date is explicitly specified. For instance, the text “present” can be converted to today's date. For a date related to education, which could be offered by schools or other service providers, where usually only the end date is specified, a start date can be inferred based on the type of education. In FIG. 4, the entity “graduation 2014” can thus be converted to a duration of 2010-2014.

### 3.2. Determining Pairs of Related Named Entities

In some embodiments, the server 102 is programmed to identify pairs of NEs that correspond to associations between skill names and skill levels. The server 102 can be programmed to look in each text segment and consider all pairs of entities tagged with categories that respectively fall in the skill name class and the skill level class in the text segment. The server 102 can be configured to consider only an entity tagged with a category that falls in the skill name class with the closest entity in the text segment that is tagged with a category that falls in the skill level class. Typically, each such pair of entities does capture a skill name and a corresponding skill level. However, exceptions can occur when an entity has been mis-categorized, when the text segment has been misidentified, or due to original errors in the resume. Further classifying such a pair of entities as containing a relationship between a skill name and a corresponding skill level using an advanced machine learning approach can provide additional assurance that the skill level can be attributed to the skill name, reducing the number of false positives in relationship classifications.

In some embodiments, therefore, the server 102 is programmed to generate an encoding for each pair of NEs for determining whether the pair can be classified as representing a relationship between a skill name and a skill level by a machine learning model. Specifically, for each NE, the server 102 can be programmed to generate an encoding, and for each pair of NEs, the server 102 can be programmed to then use the corresponding encodings together for classification. In certain embodiments, the server 102 can be configured to also consider a pair of NEs tagged with the skill category and another category that falls in the skill name class for classification. A positive classification, as further discussed later, can help confirm that the pair of NEs correspond to the same skill name, when the entity that is not tagged with the skill category is not already captured in the knowledge graph.

Referring back to the example illustrated in FIG. 4, the entities 402 and 404 are in the same sentence and thus can be in the same text segment. These two entities with their categories therefore form a pair of NEs for consideration. The entities 406 and 408 are in the same subsection and thus can be in the same text segment. These two entities with their categories therefor also form a pair of NEs for consideration. Similarly, the entities 408 and 410, the entities 412 and 414, the entities 414 and 416, the entities 414 and 418, and the entities 420 and 422 can form pairs of NEs for consideration. As noted above, the entities 406 and 410 that are respectively tagged with the job title category and the skill category can also form a pair of NEs for consideration.

As an example of how a pair of NEs in the same text segment may not represent a desired relationship, it is possible that in the Education section of the resume, some courses are listed as being relevant to the degree, which can correspond to one skill, while some other courses are listed as being relevant to the position being applied for, which can correspond to a different skill separately required by the position. Therefore, a pair of the entity for the domain of the degree and an entity for a course relevant to the position only would be classified as not representing a desired relationship that corresponds to a specific skill name.

In some embodiments, the server 102 is programmed to generate encodings for each identified pair of NEs using a second transformer-based ML model, such as MPNet described in the paper by Song et al., arXiv:2004.09297v2 [cs.CL] 2 Nov. 2020. The same custom dataset used to retrain the first ML model or a similar dataset can be used to specifically train the second ML model. In certain embodiments, the second ML model can be identical to the first ML model. MPNet is expected to lead to better learnt representations and less discrepancy with downstream tasks than other similar models because it leverages the dependency among predicted tokens through permuted language modeling and takes auxiliary position information as input to make the model see a full sentence. Therefore, the encoding for each NE effectively encodes a span around the NE that includes neighboring information. However, other existing ML models that generate encodings can be utilized.

In some embodiments, the server 102 is programmed to determine that a pair of NEs represents a desired relationship, by associating a category in the skill name class with a category in the skill level class or by associating categories in the skill name class, using a third ML model, which could be a multilayer perceptron or a feedforward neural network. The training data for the third ML model would comprise encodings for pairs of NEs that represent the desired relationships with a classification of yes and encodings for other pairs with a classification of no. Other existing ML models that determine whether two items have an expected relationship can be utilized. When the output of the third ML model concludes that a pair of entities that correspond to a skill and a job title or a domain represents a desired relationship, the server 102 can be programmed to add a subgraph representing the job title or the domain to the skill graph as being connected to the subgraph representing the skill.

### 3.3. Generating a Skill Assessment From Relationships

In some embodiments, the server 102 is programmed to further determine the skill level of a skill from the resume or a similar document using a fourth ML model. The server 102 is programmed to consider all pairs of NEs, or all those classified as representing a relationship between a skill name and a skill level, that correspond to the same skill name. This would include all the entities tagged with categories in the skill name class that are considered related in the knowledge graph or via the third ML model, as discussed above. Furthermore, the server 102 can be programmed to set up a reinforcement learning model as the fourth ML model. In a set up similar to the one described in the paper by Lin et al., arXiv:1901.01379v1 [cs.LG] 5 Jan. 2019:
State: Each state corresponds to a training sample, which corresponds to a set of embeddings for a set of pairs of NEs that correspond to a skill name. The set can be limited to a fixed size. For example, it can correspond to N related entities that are closest to one another based on their encodings. The embeddings can be computed as discussed in the previous section. The state s(t) at each time step t corresponds to the training sample x(t).
Action: Each action of an agent corresponds to a label of the training data set, which corresponds to a (combined) skill level. As illustrated in FIG. 3, at least four different labels can be available respectively corresponding to advanced, proficient, intermediate, and beginner. The action a(t) taken by the agent is to predict a class label.
Reward: Each reward corresponds to the classification result, so it can be 1 for a correct class label and −1 (or 0) for an incorrect class label.
Transition probability: The transition probability is deterministic. The agent moves from the current state s(t) to the next state s(t+1) according to the order of samples in the training data set.
Policy: The classification policy is then a function which receives a sample and return the probabilities of all labels, namely π(a|s)=P(a(t)=a|s(t)=s).

Other setups of the reinforcement learning model for classification can be used. The complexity of the classification task at hand can specifically benefit from a reinforcement model. The state space here can be large, as many different entities are possible and many pairs of these entities are possible. The states represent scope relationships in a segment of text; complicating factors involve parsing long distance syntactic relationships with intervening material such as adverbials and clause-level constituents. While distributed embeddings can capture some degree of syntactic signal, they are likely to miss some structural nuances—a deficit that can be corrected by a reinforcement model. Using a reinforcement learning model as the fourth ML model allows automatic, continued improvement of the ML model as more input including human validation is received. Each new set of pairs of NEs would constitute a new state in the continuous state space, and the policy would estimate a distribution of likelihoods for taking different actions to achieve the best reward at each time step. A user can review the estimate and provide feedback to confirm or adjust the estimate, which will update the reward function.

Referring to FIG. 4 above, all the identified pairs of NEs can be considered to represent relationships between the skill of embedded systems and similar skills and skill levels. Therefore, for the same skill name, there are different granularities and descriptors, including being an embedded system computer engineer for 2.5 years and specifically working on system-on-chip devices for up to 2.5 years, working towards a bachelor of science degree in computer engineering technology at Old Morris University and for four years, learning about wireless communications & networking for up to 0.5 years (typical length of a course), or programming C++ at the expert level. The set of embeddings for these pairs of NEs or a subset of a fixed size, as discussed above, can count as one sample. The sample can be used as input data to the fourth ML model, and the output would be a distribution of probabilities for different skill levels for the subject of the resume. A different set of pairs of NEs identified from the resume that correspond to a different skill name could also be used as input data to the fourth ML model to obtain a different distribution of probabilities for different skill levels.

In some embodiments, the server 102 is programmed to generate a skill assessment for the subject of the resume, which would indicate, for each skill name identified from a set of pairs of NEs, at least one skill level, such as the category that receives the highest probability from the fourth ML model. The server 102 can be programmed to then compare that skill assessment with a specific document of one of different types that has a list of skill names and corresponding required or expected skill levels. As one example, the specific document can be a job description or promotion guide, and the comparison can focus on whether there is an overall good match between the skill assessment and the specific document to determine whether the subject is a good candidate for a specific job via a new hire or a promotion. As another example, the specific document can be a developmental plan, and the comparison can focus on whether there is a lag in any of the skill areas relative to an expected skill level to determine how to improve the subject's skills in those skill areas. As yet another example, the specific document can be a marketing plan, and the comparison can focus on whether there is any clear advancement in any of the skill areas relative to an average skill level to determine how to increase visibility to the subject's skills in those skill areas. In other embodiments, the server 102 is programmed to update the specific documents based on one or more skill assessments. For example, based on a certain volume of resumes, when an aggregate skill level for a particular skill name is inconsistent with the required or expected skill level in a specific document, the specific document can be adjusted accordingly.

### 4. Example Processes

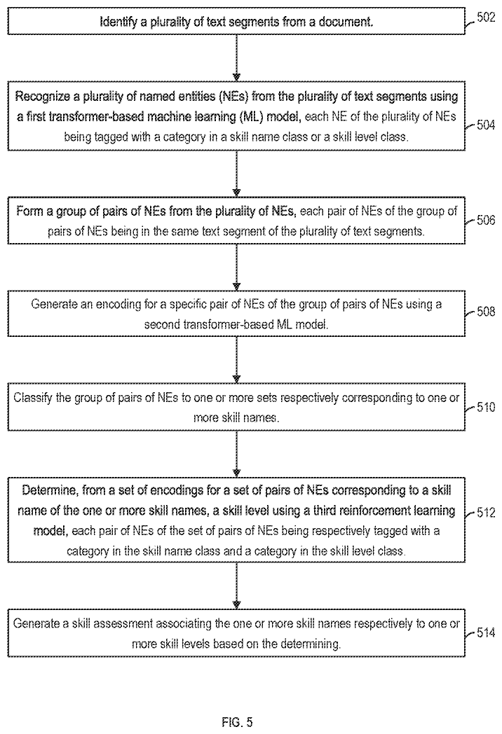

FIG. 5 illustrates an example process of determining and utilizing skill level information in accordance with some embodiments described herein. FIG. 5 is shown in simplified, schematic format for purposes of illustrating a clear example and other embodiments may include more, fewer, or different elements connected in various manners. FIG. 5 is intended to disclose an algorithm, plan, or outline that can be used to implement one or more computer programs or other software elements which when executed cause performing the functional improvements and technical advances that are described herein. Furthermore, the flow diagrams herein are described at the same level of detail that persons of ordinary skill in the art ordinarily use to communicate with one another about algorithms, plans, or specifications forming a basis of software programs that they plan to code or implement using their accumulated skill and knowledge.

In step 502, the server 102 is programmed to identify a plurality of text segments from a document. In certain embodiments, the plurality of text segments includes text segments corresponding to sections describing work or education experience or text segments corresponding to sentences in other sections of the document. In other embodiments, the document is a resume.

In step 504, the server 102 is programmed to recognize a plurality of named entities (NEs) from the plurality of text segments using a first transformer-based machine learning (ML) model. Each NE of the plurality of NEs is tagged with a category in a skill name class or a skill level class.

In certain embodiments, the server 102 is configured to manage an ontology including the skill name class and the skill level class. The skill name class includes a skill category, a domain category, and a job title category. The skill level class includes a credential category, an organization category, a level category, and a time category.

In step 506, the server 102 is programmed to form a group of pairs of NEs from the plurality of NEs. Each pair of NEs of the group of pairs of NEs is in the same text segment of the plurality of text segments.

In step 508, the server 102 is programmed to generate an encoding for a specific pair of NEs of the group of pairs of NEs using a second transformer-based ML model. In certain embodiments, the second transformer-based ML model leverages dependency among predicted tokens through permuted language modeling and takes auxiliary position information in a full sentence as input.

In specific embodiments, the server 102 is configured to create an encoding for each NE of the specific pair of NEs using the second transformer-based ML model, and concatenate the two encodings for the two NEs to form the encoding for the specific pair of NEs.

In certain embodiments, the specific pair of NEs has a first entity tagged with a first category in the skill level class and a second entity tagged with a second category in the skill name class, and the first entity appears before the second entity in the text segment.

In some embodiments, the server 102 is configured to determine that the specific pair of NEs corresponds to a specific skill name and a corresponding skill level or the specific skill name and a related skill name using a multilevel perceptron as a fourth ML model. In other embodiments, the server 102 is configured to manage a skill graph of skill names, wherein each node represents a word and each edge represents a syntactic relationship, where the classifying is based on the skill graph or a result of the determining using the fourth ML model.

In step 510, the server 102 is programmed to classify the group of pairs of NEs to one or more sets respectively corresponding to one or more skill names.

In step 512, the server 102 is programmed to determine, from a set of encodings for a set of pairs of NEs corresponding to a skill name of the one or more skill names, a skill level using a third reinforcement learning model. Each pair of NEs of the set of pairs of NEs are respectively tagged with a category in the skill name class and a category in the skill level class.

In certain embodiments, in the third reinforcement learning model, each state corresponds to a particular set of encodings for a particular set of pairs of NEs, each action from the state corresponds to classifying the particular set of encodings to generate a classification label corresponding to categories in the skill level class for the particular set of encodings, and a reward for taking the action corresponds to a result of the classifying.

In step 514, the server 102 is programmed to generate a skill assessment associating the one or more skill names respectively to one or more skill levels based on the determining.

In certain embodiments, the server 102 is configured to match the skill assessment with a specific document having a list of skill names and a corresponding list of skill levels, and transmit a result of the matching. In other embodiments, the server 102 is configured to compute an aggregate skill level for a particular skill name from a plurality of skill assessments, and update the specific document based on the aggregate skill level.

### 5. Example Implementation

According to one embodiment, the techniques described herein are implemented by at least one computing device. The techniques may be implemented in whole or in part using a combination of at least one server computer and/or other computing devices that are coupled using a network, such as a packet data network. The computing devices may be hard-wired to perform the techniques, or may include digital electronic devices such as at least one application-specific integrated circuit (ASIC) or field programmable gate array (FPGA) that is persistently programmed to perform the techniques, or may include at least one general purpose hardware processor programmed to perform the techniques pursuant to program instructions in firmware, memory, other storage, or a combination. Such computing devices may also combine custom hard-wired logic, ASICs, or FPGAs with custom programming to accomplish the described techniques. The computing devices may be server computers, workstations, personal computers, portable computer systems, handheld devices, mobile computing devices, wearable devices, body mounted or implantable devices, smartphones, smart appliances, internetworking devices, autonomous or semi-autonomous devices such as robots or unmanned ground or aerial vehicles, any other electronic device that incorporates hard-wired and/or program logic to implement the described techniques, one or more virtual computing machines or instances in a data center, and/or a network of server computers and/or personal computers.

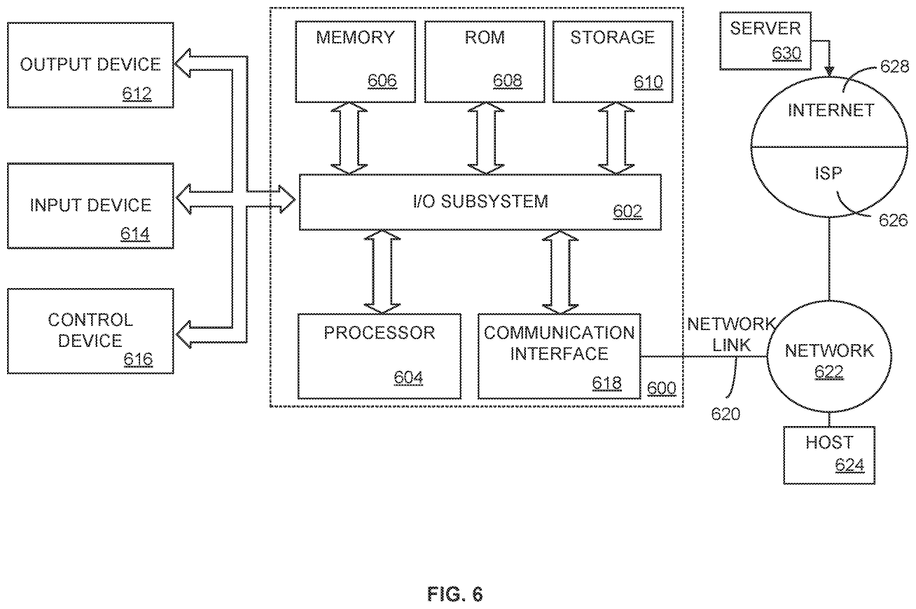

FIG. 6 is a block diagram that illustrates an example computer system with which an embodiment may be implemented. In the example of FIG. 6, a computer system 600 and instructions for implementing the disclosed technologies in hardware, software, or a combination of hardware and software, are represented schematically, for example as boxes and circles, at the same level of detail that is commonly used by persons of ordinary skill in the art to which this disclosure pertains for communicating about computer architecture and computer systems implementations.

Computer system 600 includes an input/output (I/O) subsystem 602 which may include a bus and/or other communication mechanism(s) for communicating information and/or instructions between the components of the computer system 600 over electronic signal paths. The I/O subsystem 602 may include an I/O controller, a memory controller and at least one I/O port. The electronic signal paths are represented schematically in the drawings, for example as lines, unidirectional arrows, or bidirectional arrows.

At least one hardware processor 604 is coupled to I/O subsystem 602 for processing information and instructions. Hardware processor 604 may include, for example, a general-purpose microprocessor or microcontroller and/or a special-purpose microprocessor such as an embedded system or a graphics processing unit (GPU) or a digital signal processor or Advanced RISC Machines (ARM) processor. Processor 604 may comprise an integrated arithmetic logic unit (ALU) or may be coupled to a separate ALU.

Computer system 600 includes one or more units of memory 606, such as a main memory, which is coupled to I/O subsystem 602 for electronically digitally storing data and instructions to be executed by processor 604. Memory 606 may include volatile memory such as various forms of random-access memory (RAM) or other dynamic storage device. Memory 606 also may be used for storing temporary variables or other intermediate information during execution of instructions to be executed by processor 604. Such instructions, when stored in non-transitory computer-readable storage media accessible to processor 604, can render computer system 600 into a special-purpose machine that is customized to perform the operations specified in the instructions.

Computer system 600 further includes non-volatile memory such as read only memory (ROM) 608 or other static storage device coupled to I/O subsystem 602 for storing information and instructions for processor 604. The ROM 608 may include various forms of programmable ROM (PROM) such as erasable PROM (EPROM) or electrically erasable PROM (EEPROM). A unit of persistent storage 610 may include various forms of non-volatile RAM (NVRAM), such as flash memory, or solid-state storage, magnetic disk, or optical disk such as CD-ROM or DVD-ROM, and may be coupled to I/O subsystem 602 for storing information and instructions. Storage 610 is an example of a non-transitory computer-readable medium that may be used to store instructions and data which when executed by the processor 604 cause performing computer-implemented methods to execute the techniques herein.

The instructions in memory 606, ROM 608 or storage 610 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement Transmission Control Protocol/Internet Protocol (TCP/IP), Hypertext Transfer Protocol (HTTP) or other communication protocols; file processing instructions to interpret and render files coded using HTML, Extensible Markup Language (XML), Joint Photographic Experts Group (JPEG), Moving Picture Experts Group (MPEG) or Portable Network Graphics (PNG); user interface instructions to render or interpret commands for a GUI, command-line interface or text user interface; application software such as an office suite, internet access applications, design and manufacturing applications, graphics applications, audio applications, software engineering applications, educational applications, games or miscellaneous applications. The instructions may implement a web server, web application server or web client. The instructions may be organized as a presentation layer, application layer and data storage layer such as a relational database system using structured query language (SQL) or NoSQL, an object store, a graph database, a flat file system or other data storage.

Computer system 600 may be coupled via I/O subsystem 602 to at least one output device 612. In one embodiment, output device 612 is a digital computer display. Examples of a display that may be used in various embodiments include a touch screen display or a light-emitting diode (LED) display or a liquid crystal display (LCD) or an e-paper display. Computer system 600 may include other type(s) of output devices 612, alternatively or in addition to a display device. Examples of other output devices 612 include printers, ticket printers, plotters, projectors, sound cards or video cards, speakers, buzzers or piezoelectric devices or other audible devices, lamps or LED or LCD indicators, haptic devices, actuators, or servos.

At least one input device 614 is coupled to I/O subsystem 602 for communicating signals, data, command selections or gestures to processor 604. Examples of input devices 614 include touch screens, microphones, still and video digital cameras, alphanumeric and other keys, keypads, keyboards, graphics tablets, image scanners, joysticks, clocks, switches, buttons, dials, slides, and/or various types of sensors such as force sensors, motion sensors, heat sensors, accelerometers, gyroscopes, and inertial measurement unit (IMU) sensors and/or various types of transceivers such as wireless, such as cellular or Wi-Fi, radio frequency (RF) or infrared (IR) transceivers and Global Positioning System (GPS) transceivers.

Another type of input device is a control device 616, which may perform cursor control or other automated control functions such as navigation in a graphical interface on a display screen, alternatively or in addition to input functions. Control device 616 may be a touchpad, a mouse, a trackball, or cursor direction keys for communicating direction information and command selections to processor 604 and for controlling cursor movement on the output device 612. The input device may have at least two degrees of freedom in two axes, a first axis (e.g., x) and a second axis (e.g., y), that allows the device to specify positions in a plane. Another type of input device is a wired, wireless, or optical control device such as a joystick, wand, console, steering wheel, pedal, gearshift mechanism or other type of control device. An input device 614 may include a combination of multiple different input devices, such as a video camera and a depth sensor.

In another embodiment, computer system 600 may comprise an internet of things (IoT) device in which one or more of the output device 612, input device 614, and control device 616 are omitted. Or, in such an embodiment, the input device 614 may comprise one or more cameras, motion detectors, thermometers, microphones, seismic detectors, other sensors or detectors, measurement devices or encoders and the output device 612 may comprise a special-purpose display such as a single-line LED or LCD display, one or more indicators, a display panel, a meter, a valve, a solenoid, an actuator or a servo.

When computer system 600 is a mobile computing device, input device 614 may comprise a global positioning system (GPS) receiver coupled to a GPS module that is capable of triangulating to a plurality of GPS satellites, determining and generating geo-location or position data such as latitude-longitude values for a geophysical location of the computer system 600. Output device 612 may include hardware, software, firmware, and interfaces for generating position reporting packets, notifications, pulse or heartbeat signals, or other recurring data transmissions that specify a position of the computer system 600, alone or in combination with other application-specific data, directed toward host computer 624 or server 630.

Computer system 600 may implement the techniques described herein using customized hard-wired logic, at least one ASIC or FPGA, firmware and/or program instructions or logic which when loaded and used or executed in combination with the computer system causes or programs the computer system to operate as a special-purpose machine. According to one embodiment, the techniques herein are performed by computer system 600 in response to processor 604 executing at least one sequence of at least one instruction contained in main memory 606. Such instructions may be read into main memory 606 from another storage medium, such as storage 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage 610. Volatile media includes dynamic memory, such as memory 606. Common forms of storage media include, for example, a hard disk, solid state drive, flash drive, magnetic data storage medium, any optical or physical data storage medium, memory chip, or the like.

Storage media is distinct from but may be used in conjunction with transmission media. Transmission media participates in transferring information between storage media. For example, transmission media includes coaxial cables, copper wire and fiber optics, including the wires that comprise a bus of I/O subsystem 602. Transmission media can also take the form of acoustic or light waves, such as those generated during radio-wave and infra-red data communications.

Various forms of media may be involved in carrying at least one sequence of at least one instruction to processor 604 for execution. For example, the instructions may initially be carried on a magnetic disk or solid-state drive of a remote computer. The remote computer can load the instructions into its dynamic memory and send the instructions over a communication link such as a fiber optic or coaxial cable or telephone line using a modem. A modem or router local to computer system 600 can receive the data on the communication link and convert the data to be read by computer system 600. For instance, a receiver such as a radio frequency antenna or an infrared detector can receive the data carried in a wireless or optical signal and appropriate circuitry can provide the data to I/O subsystem 602 such as place the data on a bus. I/O subsystem 602 carries the data to memory 606, from which processor 604 retrieves and executes the instructions. The instructions received by memory 606 may optionally be stored on storage 610 either before or after execution by processor 604.

Computer system 600 also includes a communication interface 618 coupled to I/O subsystem 602. Communication interface 618 provides a two-way data communication coupling to network link(s) 620 that are directly or indirectly connected to at least one communication network, such as a network 622 or a public or private cloud on the Internet. For example, communication interface 618 may be an Ethernet networking interface, integrated-services digital network (ISDN) card, cable modem, satellite modem, or a modem to provide a data communication connection to a corresponding type of communications line, for example an Ethernet cable or a metal cable of any kind or a fiber-optic line or a telephone line. Network 622 broadly represents a LAN, WAN, campus network, internetwork, or any combination thereof. Communication interface 618 may comprise a LAN card to provide a data communication connection to a compatible LAN, or a cellular radiotelephone interface that is wired to send or receive cellular data according to cellular radiotelephone wireless networking standards, or a satellite radio interface that is wired to send or receive digital data according to satellite wireless networking standards. In any such implementation, communication interface 618 sends and receives electrical, electromagnetic, or optical signals over signal paths that carry digital data streams representing various types of information.

Network link 620 typically provides electrical, electromagnetic, or optical data communication directly or through at least one network to other data devices, using, for example, satellite, cellular, Wi-Fi, or BLUETOOTH technology. For example, network link 620 may provide a connection through a network 622 to a host computer 624.

Furthermore, network link 620 may provide a connection through network 622 or to other computing devices via internetworking devices and/or computers that are operated by an Internet Service Provider (ISP) 626. ISP 626 provides data communication services through a world-wide packet data communication network represented as internet 628. A server 630 may be coupled to internet 628. Server 630 broadly represents any computer, data center, virtual machine, or virtual computing instance with or without a hypervisor, or computer executing a containerized program system such as DOCKER or KUBERNETES. Server 630 may represent an electronic digital service that is implemented using more than one computer or instance and that is accessed and used by transmitting web services requests, Uniform Resource Locator (URL) strings with parameters in HTTP payloads, application programming interface (API) calls, app services calls, or other service calls. Computer system 600 and server 630 may form elements of a distributed computing system that includes other computers, a processing cluster, server farm or other organization of computers that cooperate to perform tasks or execute applications or services. Server 630 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement TCP/IP, HTTP or other communication protocols; file format processing instructions to interpret or render files coded using HTML, XML, JPEG, MPEG or PNG; user interface instructions to render or interpret commands for a GUI, command-line interface or text user interface; application software such as an office suite, internet access applications, design and manufacturing applications, graphics applications, audio applications, software engineering applications, educational applications, games or miscellaneous applications. Server 630 may comprise a web application server that hosts a presentation layer, application layer and data storage layer such as a relational database system using structured query language (SQL) or NoSQL, an object store, a graph database, a flat file system or other data storage.

Computer system 600 can send messages and receive data and instructions, including program code, through the network(s), network link 620 and communication interface 618. In the Internet example, a server 630 might transmit a requested code for an application program through Internet 628, ISP 626, local network 622 and communication interface 618. The received code may be executed by processor 604 as it is received, and/or stored in storage 610, or other non-volatile storage for later execution.

The execution of instructions as described in this section may implement a process in the form of an instance of a computer program that is being executed, and consisting of program code and its current activity. Depending on the operating system (OS), a process may be made up of multiple threads of execution that execute instructions concurrently. In this context, a computer program is a passive collection of instructions, while a process may be the actual execution of those instructions. Several processes may be associated with the same program; for example, opening up several instances of the same program often means more than one process is being executed. Multitasking may be implemented to allow multiple processes to share processor 604. While each processor 604 or core of the processor executes a single task at a time, computer system 600 may be programmed to implement multitasking to allow each processor to switch between tasks that are being executed without having to wait for each task to finish. In an embodiment, switches may be performed when tasks perform input/output operations, when a task indicates that it can be switched, or on hardware interrupts. Time-sharing may be implemented to allow fast response for interactive user applications by rapidly performing context switches to provide the appearance of concurrent execution of multiple processes simultaneously. In an embodiment, for security and reliability, an operating system may prevent direct communication between independent processes, providing strictly mediated and controlled inter-process communication functionality.

### 6. Extensions and Alternatives

In the foregoing specification, embodiments of the disclosure have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. A computer-implemented method of determining and utilizing skill level information, comprising:
identifying a plurality of text segments from a document;
recognizing a plurality of named entities (NEs) from the plurality of text segments using a first transformer-based machine learning (ML) model,
each NE of the plurality of NEs being tagged with a category in a skill name class or a skill level class;
forming a group of pairs of NEs from the plurality of NEs,
each pair of NEs of the group of pairs of NEs being in the same text segment of the plurality of text segments;
generating an encoding for a specific pair of NEs of the group of pairs of NEs using a second transformer-based ML model;
classifying the group of pairs of NEs to one or more sets respectively corresponding to one or more skill names;
determining, from a set of encodings for a set of pairs of NEs corresponding to a skill name of the one or more skill names, a skill level using a third reinforcement learning model,
each pair of NEs of the set of pairs of NEs being respectively tagged with a category in the skill name class and a category in the skill level class;
generating a skill assessment associating the one or more skill names respectively to one or more skill levels based on the determining,
wherein the method is performed by one or more processors.

2. The computer-implemented method of claim 1, the plurality of text segments including text segments corresponding to sections describing work or education experience or text segments corresponding to sentences in other sections of the document.

3. The computer-implemented method of claim 1, the document being a resume.

4. The computer-implemented method of claim 1, further comprising
managing an ontology including the skill name class and the skill level class,
the skill name class including a skill category, a domain category, and a job title category,
the skill level class including a credential category, an organization category, a level category, and a time category.

5. The computer-implemented method of claim 1, the second transformer-based ML model leveraging dependency among predicted tokens through permuted language modeling and taking auxiliary position information in a full sentence as input.

6. The computer-implemented method of claim 1,
the specific pair of NEs having a first entity tagged with a first category in the skill level class and a second entity tagged with a second category in the skill name class,
the first entity appearing before the second entity in the text segment.

7. The computer-implemented method of claim 1, further comprising determining that the specific pair of NEs corresponds to a specific skill name and a corresponding skill level or the specific skill name and a related skill name using a multilevel perceptron as a fourth ML model.

8. The computer-implemented method of claim 7, further comprising
managing a skill graph of skill names, wherein each node represents a word and each edge represents a syntactic relationship,
the classifying being based on the skill graph or a result of the determining using the fourth ML model.

9. The computer-implemented method of claim 1, the generating comprising:
creating an encoding for each NE of the specific pair of NEs using the second transformer-based ML model;
concatenating the two encodings for the two NEs to form the encoding for the specific pair of NEs.

10. The computer-implemented method of claim 1, wherein in the third reinforcement learning model:
each state corresponds to a particular set of encodings for a particular set of pairs of NEs,
each action from the state corresponds to classifying the particular set of encodings to generate a classification label corresponding to categories in the skill level class for the particular set of encodings,
a reward for taking the action corresponds to a result of the classifying.

11. The computer-implemented method of claim 1, further comprising:
matching the skill assessment with a specific document having a list of skill names and a corresponding list of skill levels;
transmitting a result of the matching.

12. The computer-implemented method of claim 11, further comprising:
computing an aggregate skill level for a particular skill name from a plurality of skill assessments;
updating the specific document based on the aggregate skill level.

13. A system for determining and utilizing skill level information, comprising:
a memory;
one or more processors coupled to the memory and configured to perform:
identifying a plurality of text segments from a document;
recognizing a plurality of NEs from the plurality of text segments using a first transformer-based ML model,
each NE of the plurality of NEs being tagged with a category in a skill name class or a skill level class;
forming a group of pairs of NEs from the plurality of NEs,
each pair of NEs of the group of pairs of NEs being in the same text segment of the plurality of text segments;
generating an encoding for a specific pair of NEs of the group of pairs of NEs using a second transformer-based ML model;
classifying the group of pairs of NEs to one or more sets respectively corresponding to one or more skill names;
determining, from a set of encodings for a set of pairs of NEs corresponding to a skill name of the one or more skill names, a skill level using a third reinforcement learning model,
each pair of NEs of the set of pairs of NEs being respectively tagged with a category in the skill name class and a category in the skill level class;
generating a skill assessment associating the one or more skill names respectively to one or more skill levels based on the determining.

14. The system of claim 13, the one or more processors further configured to perform
managing an ontology including the skill name class and the skill level class,
the skill name class including a skill category, a domain category, and a job title category,
the skill level class including a credential category, an organization category, a level category, and a time category.

15. The system of claim 13,
the specific pair of NEs having a first entity tagged with a first category in the skill level class and a second entity tagged with a second category in the skill name class,
the first entity appearing before the second entity in the text segment.

16. The system of claim 13, the one or more processors further configured to perform determining that the specific pair of NEs corresponds to a specific skill name and a corresponding skill level or the specific skill name and a related skill name using a multilevel perceptron as a fourth ML model.

17. The system of claim 16, the one or more processors further configured to perform
managing a skill graph of skill names, wherein each node represents a word and each edge represents a syntactic relationship,
the classifying being based on the skill graph or a result of the determining using the fourth ML model.

18. The system of claim 13, the one or more processors further configured to perform:
matching the skill assessment with a specific document having a list of skill names and a corresponding list of skill levels;
transmitting a result of the matching.

19. The system of claim 18, the one or more processors further configured to perform:
computing an aggregate skill level for a particular skill name from a plurality of skill assessments;
updating the specific document based on the aggregate skill level.

20. A non-transitory, computer-readable storage medium storing one or more sequences of instructions which when executed cause one or more processors to perform:
identifying a plurality of text segments from a document;
recognizing a plurality of NEs from the plurality of text segments using a first transformer-based ML model,
each NE of the plurality of NEs being tagged with a category in a skill name class or a skill level class;
forming a group of pairs of NEs from the plurality of NEs,
each pair of NEs of the group of pairs of NEs being in the same text segment of the plurality of text segments;
generating an encoding for a specific pair of NEs of the group of pairs of NEs using a second transformer-based ML model;
classifying the group of pairs of NEs to one or more sets respectively corresponding to one or more skill names;
determining, from a set of encodings for a set of pairs of NEs corresponding to a skill name of the one or more skill names, a skill level using a third reinforcement learning model,
each pair of NEs of the set of pairs of NEs being respectively tagged with a category in the skill name class and a category in the skill level class;
generating a skill assessment associating the one or more skill names respectively to one or more skill levels based on the determining.
